(19) United States
(12) Patent Application Publication
(10) Pub. No.: US 2017/0145243 A1
(43) Pub. Date: May 25, 2017

(54) METHOD OF MANUFACTURING HYDROPHOBIC MATERIAL AND HYDROPHOBIC FILM

(71) Applicant: INDUSTRIAL TECHNOLOGY RESEARCH INSTITUTE, Hsinchu (TW)

(72) Inventors: Wei-Cheng TANG, Hsinchu City (TW); Yi-Che SU, Zhubei City (TW); Yun-Shan HUANG, Zhunan Township (TW)

(73) Assignee: INDUSTRIAL TECHNOLOGY RESEARCH INSTITUTE, Hsinchu (TW)

(21) Appl. No.: 14/984,493

(22) Filed: Dec. 30, 2015

(30) Foreign Application Priority Data
Nov. 20, 2015 (TW) 104138433

(51) Int. Cl. C09D 133/02; B05D 3/00

(52) U.S. Cl. CPC C09D 133/02; B05D 3/007

(57) ABSTRACT

A method of manufacturing a hydrophobic material is provided, which includes: (a) mixing a sol-gel precursor, water, and catalyst to perform a sol-gel reaction for forming a solution having particles therein, (b) modifying the particles with a hydrophobic agent to form surface-modified particles, (c) adding a small-molecular surfactant to the solution containing the surface-modified particles to form a first dispersion, (d) mixing a resin, a water soluble polymer, and water to form a second dispersion, and (e) mixing the first dispersion and the second dispersion to obtain a hydrophobic material.

### CROSS REFERENCE TO RELATED APPLICATIONS

The present application is based on, and claims priority from, Taiwan Application Serial Number 104138433, filed on Nov. 20, 2015 the disclosure of which is hereby incorporated by reference herein in its entirety.

### TECHNICAL FIELD

The technical field relates to a method of manufacturing hydrophobic material and hydrophobic film.

### BACKGROUND

Aqueous coating materials have become a necessary developmental trend due to demands for environmental protection and related global and local laws. In the United States, the value of the aqueous coating ratio in coating material including hydrophobic material output is over 50%. In Germany, that number is over 45%. The development of aqueous coating has gradually grown to meet the requirements for environmentally friendly chemistry and energy. In recent years, aqueous hydrophobic anti-fouling coating material has attracted worldwide attention due to its functions, its relatively low environmental impact, its applicability as waterproof electronic package coating, water-repellent shoe material, anti-fouling building material, anti-fouling mobile coating, and similar applications.

Accordingly, a novel method and formula (or composition) for a hydrophobic material with hydrophobicity and excellent adherence to a substrate are required.

### SUMMARY

One embodiment of the disclosure provides a method of manufacturing a hydrophobic material, comprising: (a) mixing a sol-gel precursor, water, and catalyst to perform a sol-gel reaction for forming a solution having particles therein; (b) modifying the particles with a hydrophobic agent to form surface-modified particles; (c) adding a small-molecular surfactant to the solution containing the surface-modified particles to form a first dispersion; (d) mixing a resin, a water soluble polymer, and water to form a second dispersion; and (e) mixing the first dispersion and the second dispersion to obtain a hydrophobic material.

One embodiment of the disclosure provides a method of forming a hydrophobic film, comprising: forming a hydrophobic material by the described method; forming the hydrophobic material on a substrate; and drying or solidifying the hydrophobic material to form a hydrophobic film.

A detailed description is given in the following embodiments.

### DETAILED DESCRIPTION

In the following detailed description, for the purposes of explanation, numerous specific details are set forth in order to provide a thorough understanding of the disclosed embodiments. It will be apparent, however, that one or more embodiments may be practiced without these specific details.

In one embodiment, the hydrophobic material is manufactured as indicated below. First, (a) a sol-gel precursor, water, and catalyst are mixed to perform a sol-gel reaction, thereby forming a solution having particles therein. In one embodiment, the ratios of ingredients in the solution having particles therein are shown below: 1 part by weight of the sol-gel precursor, 50 to 99.9 parts by weight of water, and 0.01 to 5 parts by weight of the catalyst. Too much water may cause precipitation or gelation. Too little water may result in an incomplete reaction. Too much catalyst may lead the solution to be incompatible with resins or to corrode the substrate. Too little catalyst may bring on larger particle sizes and even the precipitation in solution.

The sol-gel precursor may have, for example, a -MOR or -MOH functional group, wherein M is Si, Al, Ti, or Zr, R is Cₙ-H₂ₙ₊₁, and n is a positive integer (e.g. 1 to 4). For Example, the sol-gel precursor can be tetramethoxysilane (TMOS), tetraethoxysilane (TEOS), titanium tetraisopropoxide, titanium tetramethoxide, titanium tetraethoxide, titanium tetrabutoxide, aluminum tri-sec-butoxide, zirconium n-butoxide, or the like. For example, the catalyst can be organic acid/base or inorganic acid/base, such as hydrochloric acid, sulfuric acid, nitric acid, acetic acid, potassium hydroxide, sodium hydroxide, ammonia, or the like.

In one embodiment, the sol-gel reaction in step (a) is free of any organic solvent, such that the resulting hydrophobic material can have a low content of volatile organic compounds (VOCs). An organic solvent is generally used in a conventional sol-gel reaction to stabilize the reactants. In one embodiment, the sol-gel reaction can be reacted for about 1 hour to about 3.5 hours without using the organic solvent. When the reaction time is too long, for example, more than 3.5 hours, the solution having particles therein cannot continue the sol-gel reaction due to gelation or precipitation. However, if the reaction time is not long enough, for example, less than 1 hour, the sol-gel reaction may be incomplete. In addition, the sol-gel reaction in step (a) may be performed at room temperature, or at about 15° C. to 40° C. An overly high reaction temperature may cause the reaction solution to become gelatinized or precipitated. An overly low reaction temperature may cause the reaction be incomplete.

Next, in step (b), a hydrophobic agent is added to the solution having the particles in step (a) to chemically modify the particles. In one embodiment, 0.01 to 30 parts (or 0.05 to 5 parts) by weight of the hydrophobic agent is utilized on the basis of 1 part by weight of the sol-gel precursor. Too much hydrophobic agent may cause the surface-modified particles have a poor dispersity in water. Too little hydrophobic agent may reduce the anti-fouling properties of the product.

The hydrophobic agent can be a silicon-based hydrophobic agent, a fluorine-based hydrophobic agent, a carbohydrate hydrophobic agent, a hydrocarbon hydrophobic agent, or a combination thereof. The silicon-based hydrophobic agent can be siloxane, silane, silicone, or a combination thereof. The fluorine-based hydrophobic agent can be fluorosilane, fluoroalkylsilane (FAS), polytetrafluoroethylene (PTFE), polytrifluoroethylene, polyvinyl fluoride, functional fluoroalkyl compound, or a combination thereof. The carbohydrate hydrophobic agent or the hydrocarbon hydrophobic agent can be reactive wax, polyethylene, polypropylene, or a combination thereof.

In step (b), since the hydrophobic agent and the solution having the particles therein are separated into two layers (phases) after mixing, the chemical modifying reaction substantially occurs at an interface between the solution and the hydrophobic agent. After the reaction continues for a period of time, for example, after 1 hour to 2 hours, the hydrophobic agent may be substantially grafted to the particles. An overly short reaction time may lead to an incomplete reaction and lower the anti-fouling properties of the coating material. An overly long reaction time may cause the surface-modified particles to have a poor dispersity in water. The reaction may be performed at room temperature, or at about 15° C. to 40° C. An overly high reaction temperature may cause precipitation or gelation. An overly low reaction temperature may reduce the reaction rate and even cause an incomplete reaction.

Next, in step (c), a small-molecular surfactant is added to the solution with surface-modified particles therein to form a first dispersion. In one embodiment, 0.01 to 5 parts by weight (or 0.05 to 1 parts by weight) of the small-molecular surfactant is utilized on the basis of 1 part by weight of the sol-gel precursor. If there is too little small-molecular surfactant, the modification reaction may be incomplete or the resulting product may not be stable in an aqueous solution. However, if there is too much small-molecular surfactant, the hydrophobicity of the resulting antifouling hydrophobic material may decrease and the cost of the process may increase. In one embodiment, the small-molecular surfactant has a molecular weight of about 100 to 1000, or about 200 to 600. A small-molecular surfactant with an overly small molecular weight will make the surface-modified particles have a poor dispersity. A small-molecular surfactant with an overly large molecular weight may completely encapsulate the hydrophobic molecules, thereby reducing the hydrophobicity of the coating material.

The small-molecular surfactant can be an anionic surfactant, a combination of an anionic surfactant and a cationic surfactant, a combination of an anionic surfactant and a non-ionic surfactant, a combination of anionic surfactant and an amphoteric surfactant, or a combination thereof. If the small-molecular surfactant is free of the anionic surfactant, the surface-modified particles may have a poor dispersity in water.

In step (c), the small-molecular surfactant is diffused to the surface of the surface-modified particles to encapsulate the surface-modified particles, such that the encapsulated particles can be stabilized in water. This step usually requires a certain reaction time, such as between 12 hours and 24 hours. An overly short reaction time may cause the solution remaining separated as two layers or an incomplete reaction. An overly long reaction time may generate the higher cost of production. By adding the small-molecular surfactant, the first dispersion can be stable in an aqueous solution, and will not be separated into different phases after a period of time due to the hydrophobic characteristics of the surface-modified particles. In one embodiment, the small-molecular surfactant is not added to the solution with surface-modified particles therein until the particles are substantially modified by the hydrophobic agent. If the surfactant and the hydrophobic agent are simultaneously added to the solution having the particles, the particles will be incompletely modified, and the phase separation problem may occur.

In one embodiment, in step (d), mixing resin, water-soluble polymer, and water to form a second dispersion. Note that step (d) is not necessarily performed after step (c), and it can be performed before, during, or after steps (a) to (c) of forming the first dispersion. In one embodiment, the resin can be polyacrylic acid resin, polyurethane resin, or epoxy resin. The water-soluble polymer can be polyester, polyethylene glycol, or polyvinyl alcohol. 1 to 30 parts by weight (or about 3 to 10 parts by weight) of the resin, 0.01 to 5 parts by weight (or about 0.05 to 1 parts by weight) of the water-soluble polymer, and 1 to 100 parts by weight (or about 5 to 50 parts by weight) of the water are utilized on the basis of 1 part by weight of the sol-gel precursor. Too little resin cannot improve the adherence of the final hydrophobic material to the substrate. Too much resin may cause an overly thick hydrophobic film. Too little water-soluble polymer cannot efficiently hinder the resin, such that the particles modified by the hydrophobic particles will be adhered by the resin. Too much water-soluble polymer may be dissolved out during drying the hydrophobic material to form a hydrophobic film. Too little water may result in an overly viscous dispersion. Too much water may cause a poor coating uniformity of the coating material. In one embodiment, the water-soluble polymer has a weight average molecular weight of about 1000 to 30000, or about 1500 to 15000. A water-soluble polymer with an overly low weight average molecular weight cannot completely hinder the resin. A water-soluble polymer with an overly high weight average molecular weight easily makes an overly viscous dispersion.

In step (d), the water soluble polymer may hinder the resin and disperse in water, thereby avoiding the resin adhering onto the surface-modified particles in the following steps. In one embodiment, the mixing of step (d) is performed for a period of about 0.1 hour to 2 hours at a temperature of 20° C. to 60° C. If the mixing period is too short, the water-soluble polymer cannot efficiently hinder the resin. An overly long mixing period may extend the total process period. An overly low mixing temperature will extend the mixing period. An overly high mixing temperature may cause the resin to aggregate or precipitate.

Subsequently, in step (e), mixing the first dispersion and the second dispersion to form a coating material. If the water-soluble polymer, the resin, and the small-molecular surfactant are directly concurrently added into the solution containing the surface-modified particles therein, the resin may adhere onto the surface-modified particles. As a result, the final hydrophobic material lacks of hydrophobicity.

In one embodiment, the hydrophobic material may cover a substrate (e.g. by coating), and then be dried or solidified to form a hydrophobic film. In one embodiment, the hydrophobic film has a water contact angle of greater than 95°, greater than 100°, or even greater than 105°. The hydrophobic film after an abrasion test of 400 times through the standard ASTM D4060 still has a water contact angle of greater than 95°, greater than 100°, or even greater than 105°. Obviously, the hydrophobic film simultaneously has adherence and hydrophobicity. Alternatively, a commercially available paint can be formed (e.g. coated) on the substrate, and the hydrophobic material is then covered (e.g. coated) on the paint to serve as a protection coat of the paint. The hydrophobic film includes properties such as (but not limited to) high coating ability, adherence, hydrophobicity, anti-fouling, climate resistance, solvent resistance, and the like.

Below, exemplary embodiments will be described in detail so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1

0.8 g of tetraethyl orthosilicate (TEOS), 0.277 g of water, and 0.32 g of HCl (0.1N) were mixed to react for 3 hours at room temperature, thereby obtaining a solution having particles therein. 0.8 g of 1H,1H,2H,2H-perfluorodecyltriethoxysilane (F-8261, commercially available from Degussa) was then added into the solution having the particles therein to react at room temperature for 2 hours, thereby modifying the particles by the hydrophobic agent. 0.0384 g of anionic surfactant sodium dodecyl(ester) sulfate (SDS) was dissolved into 24.94 g of water, and the SDS solution was then added into the solution containing the surface-modified particles to react at room temperature for 12 hours, thereby obtaining a first dispersion stable in aqueous phase.

3.64 g of polyacrylic acid resin (CG-8060, commercially available from LIDYE CHEMICAL) and 0.0364 g of water-soluble polymer (sulfonic polyester AQ55S, commercially available from Eastman Chemical), were mixed at room temperature for 1 hour to form a second dispersion stable in aqueous phase. The first dispersion and the second dispersion were mixed to form a hydrophobic material with the appearance of being evenly dispersed. The hydrophobic material was coated onto a planar substrate of thermoplastic polyurethane (TPU), baked at 120° C. for 30 minutes, and cooled to complete a hydrophobic film. The hydrophobic film had a water contact angle of 111.6° and an adherence of 100/100. After the abrasion test of the standard ASTM D4060 for 400 times, the hydrophobic film had a contact angle of 115.2°. The initial amounts of the materials of the hydrophobic material and the properties of the hydrophobic film are listed in Table 1.

### Example 2

Example 2 was similar to Example 1, and the difference in Example 2 was the hydrophobic agent being changed from the fluorine-based F-8261 to the non-fluorine-based Silquest A137 (commercially available from Momentive). Other factors of the process and the initial amount of each material in Example 2 were similar to that in Example 1. The hydrophobic material was coated onto a planar substrate of thermoplastic polyurethane (TPU), baked at 120° C. for 30 minutes, and cooled to complete a hydrophobic film. The hydrophobic film had a water contact angle of 102.7° and an adherence of 100/100. After the abrasion test of the standard ASTM D4060 for 400 times, the hydrophobic film had a contact angle of 100.4°. The initial amounts of the materials of the hydrophobic material and the properties of the hydrophobic film are listed in Table 1.

### Comparative Example 1

Comparative Example 1 was similar to Example 1, and the difference in Comparative Example 1 was the step of mixing the water-soluble polymer and the resin to form the second dispersion being omitted. In Comparative Example 1, the resin CG-8060 was directly added into the first dispersion. Other factors of the process and the initial amount of each material in Comparative Example 1 were similar to that in Example 1. The hydrophobic material was coated onto a planar substrate of thermoplastic polyurethane (TPU), baked at 120° C. for 30 minutes, and cooled to complete a hydrophobic film. The hydrophobic film had a water contact angle of 79.1° and an adherence of 100/100. While the water-soluble polymer was absent, the resin would adhere onto the surface-modified particles to reduce the hydrophobicity of the hydrophobic film. The initial amounts of the materials of the hydrophobic material and the properties of the hydrophobic film are listed in Table 1.

### Comparative Example 2

The first dispersion in Example 1 was directly coated onto a planar substrate of thermoplastic polyurethane (TPU), baked at 120° C. for 30 minutes, and cooled to complete a hydrophobic film. The hydrophobic film had a water contact angle of 110.1° and very poor adherence. While the resin was absent, the hydrophobic film of the first dispersion and the substrate had insufficient adherence. The initial amounts of the materials of the hydrophobic material and the properties of the hydrophobic film are listed in Table 1.

### Comparative Example 3

Comparative Example 3 was similar to Example 1, and the difference in Comparative Example 3 was the water-soluble polymer for dispersing the resin being replaced with 0.0364 g of small-molecular surfactant SDS. Other factors of the process and the initial amount of each material in Comparative Example 3 were similar to that in Example 1. The hydrophobic material was coated onto a planar substrate of thermoplastic polyurethane (TPU), baked at 120° C. for 30 minutes, and cooled to complete a hydrophobic film. The hydrophobic film had a water contact angle of 91.9° and an adherence of 100/100. While the small-molecular surfactant could not hinder the resin to form the second dispersion as the water-soluble polymer did, the resin would adhere onto the surface-modified particles to reduce the hydrophobicity of the hydrophobic film. The initial amounts of the materials of the hydrophobic material and the properties of the hydrophobic film are listed in Table 1.

### Comparative Example 4

Comparative Example 4 was similar to Example 1, and the differences in Comparative Example 4 were the hydrophobic agent being changed from the fluorine-based F-8261 to the non-fluorine-based Silquest A137, and the water-soluble polymer for dispersing the resin being replaced with 0.0364 g of small-molecular surfactant SDS. Other factors of the process and the initial amount of each material in Comparative Example 4 were similar to that in Example 1. The hydrophobic material was coated onto a planar substrate of thermoplastic polyurethane (TPU), baked at 120° C. for 30 minutes, and cooled to complete a hydrophobic film. The hydrophobic film had a water contact angle of 82.1° and an adherence of 100/100. While the small-molecular surfactant could not hinder the resin to form the second dispersion as the water-soluble polymer did, the resin would adhere onto the surface-modified particles to reduce the hydrophobicity of the hydrophobic film. The initial amounts of the materials of the hydrophobic material and the properties of the hydrophobic film are listed in Table 1.

### Comparative Example 5

Comparative Example 5 was similar to Example 1, and the difference in Comparative Example 5 was the small-molecular surfactant SDS for dispersing the surface-modified particles being replaced with 0.0384 g of water-soluble polymer AQ55S, and the water-soluble polymer for dispersing the resin being replaced with 0.0364 g of small-molecular surfactant SDS. Other factors of the process and the initial amount of each material in Comparative Example 5 were similar to that in Example 1. Precipitation occurred in the coating material. The initial amounts of the materials and the properties of the hydrophobic material are listed in Table 1.

### Comparative Example 6

Comparative Example 6 was similar to Example 1, and the differences in Comparative Example 6 were the hydrophobic agent being changed from the fluorine-based F-8261 to the non-fluorine-based Silquest A137, the small-molecular surfactant SDS for dispersing the surface-modified particles being replaced with 0.0384 g of water-soluble polymer AQ55S, and the water-soluble polymer for dispersing the resin being replaced with 0.0364 g of small-molecular surfactant SDS. Other factors of the process and the initial amount of each material in Comparative Example 6 were similar to that in Example 1. The hydrophobic material was separated into two layers. The initial amounts of the materials and the properties of the hydrophobic material are listed in Table 1.

### Comparative Example 7

Comparative Example 7 was similar to Example 1, and the difference in Comparative Example 7 was the small-molecular surfactant SDS for dispersing the surface-modified particles being replaced with 0.0384 g of water-soluble polymer AQ55S. Other factors of the process and the initial amount of each material in Comparative Example 7 were similar to that in Example 1. Precipitation occurred in the coating material. The initial amounts of the materials and the properties of the hydrophobic material are listed in Table 1.

### Comparative Example 8

Comparative Example 8 was similar to Example 1, and the differences in Comparative Example 8 were the hydrophobic agent being changed from the fluorine-based F-8261 to the non-fluorine-based Silquest A137, and the small-molecular surfactant SDS for dispersing the surface-modified particles being replaced with 0.0384 g of water-soluble polymer AQ55S. Other factors of the process and the initial amount of each material in Comparative Example 8 were similar to that in Example 1. The hydrophobic material was separated into two layers. The initial amounts of the materials and the properties of the hydrophobic material are listed in Table 1.

### Comparative Example 9

Comparative Example 9 was similar to Example 1, and the differences in Comparative Example 8 were the small-molecular surfactant SDS for dispersing the surface-modified particles being replaced with a mixture of 0.0384 g of SDS and 0.0364 g of AQ55S, and the step of mixing the water-soluble polymer and the resin to form the second dispersion being omitted. In Comparative Example 9, the resin CG-8060 was directly added into the first dispersion. Other factors of the process and the initial amount of each material in Comparative Example 9 were similar to that in Example 1. The hydrophobic material was coated onto a planar substrate of thermoplastic polyurethane (TPU), baked at 120° C. for 30 minutes, and cooled to complete a hydrophobic film. The hydrophobic film had a water contact angle of 90.7° and an adherence of 100/100. While the step of hindering the resin by the water-soluble polymer to form a second dispersion was absent, the resin still adhered onto the surface-modified particles to reduce the hydrophobicity of the hydrophobic film. The initial amounts of the materials of the hydrophobic material and the properties of the hydrophobic film are listed in Table 1.

TABLE 1

| | First dispersion | | | | | Second dispersion | | | | | |
|---|---|---|---|---|---|---|---|---|---|---|---|
| | | | | Small- | Water- | | Small- | Water- | | | Water angle |
| | | Hydrophobic | | molecular | soluble | | molecular | soluble | Water | | after abrasion |
| | | agent | | surfactant | polymer | Resin | surfactant | polymer | contact | | test for |
| | TEOS | F-8261 | A137 | SDS | AQ55S | CG-8060 | SDS | AQ55S | angle | Adherence | 400 times |
| Example 1 | 0.8 | 0.8 | 0 | 0.0384 | 0 | 3.64 | 0 | 0.0364 | 111.6° | 100/100 | 105.2° |
| Example 2 | 0.8 | 0 | 0.8 | 0.0384 | 0 | 3.64 | 0 | 0.0364 | 102.7° | 100/100 | 100.4° |
| Comparative | 0.8 | 0.8 | 0 | 0.0384 | 0 | 3.64 | 0 | 0 | 79.1° | 100/100 | Not |
| Example 1 | | | | | | | | | | | measured |
| Comparative | 0.8 | 0 | 0.8 | 0.0384 | 0 | 0 | 0 | 0 | 110.1° | Very poor | Not |
| Example 2 | | | | | | | | | | | measured |
| Comparative | 0.8 | 0.8 | 0 | 0.0384 | 0 | 3.64 | 0.0364 | 0 | 91.9° | 100/100 | Not |
| Example 3 | | | | | | | | | | | measured |
| Comparative | 0.8 | 0 | 0.8 | 0.0384 | 0 | 3.64 | 0.0364 | 0 | 82.1° | 100/100 | Not |
| Example 4 | | | | | | | | | | | measured |
| Comparative | 0.8 | 0.8 | 0 | 0 | 0.0384 | 3.64 | 0.0364 | 0 | Precipitated | | |
| Example 5 | | | | | | | | | | | |
| Comparative | 0.8 | 0 | 0.8 | 0 | 0.0384 | 3.64 | 0.0364 | 0 | Separated into two layers | | |
| Example 6 | | | | | | | | | | | |
| Comparative | 0.8 | 0.8 | 0 | 0 | 0.0384 | 3.64 | 0 | 0.0364 | Precipitated | | |
| Example 7 | | | | | | | | | | | |
| Comparative | 0.8 | 0 | 0.8 | 0 | 0.0384 | 3.64 | 0 | 0.0364 | Separated into two layers | | |
| Example 8 | | | | | | | | | | | |
| Comparative | 0.8 | 0.8 | 0 | 0.0384 | 0.0364 | 3.64* | 0 | 0 | 90.7° | 100/100 | Not |
| Example 9 | | | | | | | | | | | measured |

*The resin, the SDS, and the AQ55S were simultaneously added into the solution having the surface-modified particles.

It will be apparent to those skilled in the art that various modifications and variations can be made to the disclosed methods and materials. It is intended that the specification and examples be considered as exemplary only, with a true scope of the disclosure being indicated by the following claims and their equivalents.

What is claimed is:

1. A method of manufacturing a hydrophobic material, comprising:
(a) mixing a sol-gel precursor, water, and catalyst to perform a sol-gel reaction for forming a solution having particles therein;
(b) modifying the particles with a hydrophobic agent to form surface-modified particles;
(c) adding a small-molecular surfactant to the solution containing the surface-modified particles to form a first dispersion;
(d) mixing a resin, a water soluble polymer, and water to form a second dispersion; and
(e) mixing the first dispersion and the second dispersion to obtain a hydrophobic material.

2. The method as claimed in claim 1, wherein step (a), step (b), step (c) and step (d) are performed with the following ratios:
1 part by weight of the sol-gel precursor;
50 to 99.9 parts by weight of the water;
0.01 to 5 parts by weight of the catalyst;
0.01 to 30 parts by weight of the hydrophobic agent;
0.01 to 5 parts by weight of the small-molecular surfactant;
1 to 30 parts by weight of the resin; and
0.01 to 5 parts by weight of the water-soluble polymer.

3. The method as claimed in claim 1, wherein step (a), step (b), step (c), step (d), and step (e) are performed without any organic solvent.

4. The method as claimed in claim 1, wherein the sol-gel precursor is a compound with a -MOR or a -MOH functional group, wherein M is Si, Ti, Al, or Zr, R is Cₙ-H₂ₙ₊₁, and n is a positive integer.

5. The method as claimed in claim 1, wherein the hydrophobic agent comprises silicon-based hydrophobic agent, a fluorine-based hydrophobic agent, a carbohydrate hydrophobic agent, a hydrocarbon hydrophobic agent, or a combination thereof.

6. The method as claimed in claim 1, wherein the small-molecular surfactant comprises anionic surfactant, a combination of an anionic surfactant and a cationic surfactant, a combination of an anionic surfactant and a non-ionic surfactant, a combination of anionic surfactant and an amphoteric surfactant, or a combination thereof.

7. The method as claimed in claim 1, wherein the resin comprises polyacrylic acid resin, polyurethane resin, or epoxy resin.

8. The method as claimed in claim 1, wherein the water-soluble polymer comprises polyester, polyethylene glycol, or polyvinyl alcohol.

9. The method as claimed in claim 1, further comprising:
vacuum distilling the hydrophobic material to remove alcohol formed by the sol-gel reaction.

10. A method of forming a hydrophobic film, comprising:
forming a hydrophobic material by the method as claimed in claim 1;
forming the hydrophobic material on a substrate; and
drying or solidifying the hydrophobic material to form the hydrophobic film.

11. The method as claimed in claim 10, further comprising a step of forming a paint on the substrate, and then covering the hydrophobic material on the paint.
